(19) United States
(12) Patent Application Publication
(10) Pub. No.: US 2002/0125700 A1
(43) Pub. Date: Sep. 12, 2002

(54) Method and apparatus for controlling the deployment of an air bag

(76) Inventor: Rick Alexander Adkisson, Matthews, NC (US)

Correspondence Address: Susan D. Reinecke, MAYER, BROWN & PLATT, P.O. Box 2828, Chicago, IL, 60690-2828, US

(21) Appl. No.: 10/015,080

(22) Filed: Dec. 11, 2001

Related U.S. Application Data
(63) Continuation-in-part of application No. 09/524,369, filed on Mar. 14, 2000.
(63) Continuation-in-part of application No. 09/523,874, filed on Mar. 13, 2000.

(51) Int. Cl. B60R 21/18

(52) U.S. Cl. 280/733

(57) ABSTRACT

A tamper-resistant cover for an air bag and an apparatus and method for controlling the deployment of an air bag is disclosed. The tamper-resistant cover includes one or more regions in a surface of the tamper-resistant cover that is/are less tear-resistant than the material which is used throughout the remaining portions of the cover. This tearable portion or portions readily rips upon deployment of the air bag when pressurized gas rapidly fills the underlying air bag thereby allowing rapid deployment of the air bag as desired. Selective locations for the tearable region or regions on the cover desirably may be used to assist in altering the way in which the air bag deploys during a crash or other impact. The tearable regions on the bag cover may be formed in a variety of different ways. For example, the tearable regions maybe formed by providing mechanical wear to the desired region on the cover. Alternatively, the tearable region or regions may be formed by creating the cover from first and second portions of cover material and affixing to these portions connecting elements. Deployment of the air bag is achieved by varying the thicknesses of the connecting elements. Deployment of the air bag is further controlled with the additional use of a self-centering air bag.

This is a continuation-in-part of pending U.S. patent application Ser. No. 09/524,369 entitled “AIR BAG CONSTRUCTION” filed on Mar. 14, 2000, and pending U.S. patent application Ser. No. 09/523,873 entitled “SELF-CENTERING AIRBAG AND METHOD FOR MANUFACTURING AND TUNING THE SAME” filed on Mar. 13, 2000. Both of these applications are incorporated herein by reference.

### BACKGROUND OF THE INVENTION

1. Field of the Invention

The present invention is generally directed to the field of automatic air bag deployment systems. More specifically, the present invention is directed to a method and apparatus for controlling the order and direction of air bag deployment.

2. Description of the Related Art

Air bag deployment systems are generally known in the field and have been widely used in the automobile industry. The majority of these deployment mechanisms employ a cover which separates from a top of a housing that encloses an air bag prior to deployment. More recently, air bags have been suggested for use in aircraft where they will be deployed directly from seatbelts in front of passengers.

Currently, there is no existing cover that is both aesthetically pleasing and tamper-resistant but yet will not interfere with the deployment of the air bag for air bags that are deployed from a seat belt location. The cover must deploy with minimum resistance and must not cause injury to an occupant during deployment of the air bag. Additionally, the cover must not shred the fabric of the air bag during deployment while being tamper resistant and aesthetically pleasing.

Accordingly, there remains a need in the art for a cover which can be used as an enclosure for an air bag mounted on a seat belt and a method for deploying the air bag through the cover in a controlled manner which satisfies each of the requirements set forth above. The inventors of the present application have discovered an air bag cover for an air bag located on a seat belt and an apparatus and method for controlling the deployment of the air bag through the cover that satisfies each of these requirements. It will be apparent to those skilled in the art that the devices described herein satisfy each of these requirements in light of the following Summary and Detailed Description of the presently preferred embodiments.

### SUMMARY OF THE INVENTION

In accordance with the present invention, an air bag that is preferably deployed over and/or around a top surface of a seatbelt has a tamper-resistant cover. The tamper-resistant cover includes one or more regions in a surface of the tamper-resistant cover that is less tear-resistant than the material which is used throughout the remaining portions of the cover. This tearable portion or portions readily rips upon deployment of the air bag when pressurized gas rapidly fills the underlying air bag thereby allowing rapid deployment of the air bag as desired. The remaining portions of the cover material do not tear as readily as the tearable regions. Alternatively, a connection between two flap members may form the weakened portion of the cover to allow deployment of an air bag from beneath the cover.

Advantageously, the cover does not interfere with the deployment of the air bag and also provides a tamper-resistant aesthetically pleasing cover. A further feature and advantage of the tamper-resistant cover of the present invention is that the selective location of the weakened region or regions on the cover desirably may be used to assist in altering the way in which the air bag deploys during a crash or other impact.

For example, a tearable portion of the cover may be centrally located on a top surface of the tamper-resistant cover. When tearable portion is located in the central region of the top surface, with out any other such tearable regions on the cover, the bag will initially expand and deploy through the central region of the cover. Alternatively, if a pair of tearable regions are centrally located on two separate sides of the top of the belt, the air bag deployment will occur initially through these two regions and then expand out therefrom until the cover is opened substantially along its entire length.

This feature of the present invention may be used to control deployment of the bag in a predetermined sequence. This may be important if it is desirable to control the application of pressure front the bag on the occupant or internal surfaces of the passenger compartment. Specifically, this feature maybe used to control movement of an occupant's body or prevent contact between certain surfaces within the passenger compartment and the passenger. For example, for a passenger located adjacent the right side wall of an airplane, it may be desirable to have the air bag deploy such that the right side of the bag deploys initially and the remaining bag expands out from the expanded right side in order to cushion the passsenger from impact with the side wall. In order to achieve this affect, the bag cover has a tearable portion located on the right side. It will be apparent to those skilled in the art that the weakened region may be placed in a wide variety of locations depending upon the desired effect.

The tearable regions on the bag cover may be formed in a variety of different ways. All that is necessary is that the tearable region provide less resistance to tearing than the remaining portions of the cover assembly. For example, the tearable regions may be formed by providing mechanical wear to the desired region on the cover. Alternatively, the tearable region or regions may be formed by creating an ultra-sonic tear seam or through the use of a tear tab or tear strip formed into the cover. It is preferred that the tearable region be formed of an ultra-sonic tear seam formed in a cover comprised of a polymer material. This is preferred because the material will not shread the bag fabric during deployment and will not significantly limit deployment of the bag or cause injury to the occupant. Furthermore, the selection of this material provides a tamper-resistant cover that is also aesthetically pleasing.

In a further alternate embodiment, when cover flaps are joined over the top of an air bag and belt structure, the flaps may be joined together with ultrasonic welding or mechanical stitching of tearable elements or connecting elements that either break apart or detach from the flap cover material. The detachment or separation of these elements provides for rapid deployment of an air bag. In one preferred embodiment, I-shaped elements are sewn or welded across a seam between two cover flaps. These I-shaped structures break apart during deployment and allow the flap members to separate. The use of I-shaped connection elements is exemplary only and other connection elements may be used as well. In a further alternate embodiment, connecting elements with varying thicknesses are used to control the order and direction of deployment. In a further alternate embodiment, connecting elements with varying thicknesses are used in combination with a self-centering air bag to further control the deployment of the air bag.

### BRIEF DESCRIPTION OF THE DRAWINGS

FIG. 1 illustrates a first preferred embodiment of the present invention;

FIG. 2 illustrates a cross-sectional side view of the embodiment of the present invention set forth in FIG. 1;

FIG. 3 illustrates a cross-sectional view of a further embodiment of the present invention wherein two sides of a cover are secured to a restraining belt;

FIG. 4 illustrates a further alternate embodiment of the present invention wherein a unitary member surrounds an air bag and seatbelt assembly;

FIG. 5 illustrates a cross-sectional side view of the air bag cover illustrated in FIG. 4; and

FIG. 6 illustrates a tear seam in accordance with the present invention.

FIG. 7 illustrates connection elements for connecting separate cover flap members.

FIG. 8 illustrates connection elements with varying center portions for connecting separate cover flap members.

FIG. 9 illustrates alternate embodiments of the connection element.

FIG. 10 illustrates an alternate embodiment of the thickness of the connection element.

FIG. 11 illustrates a sample embodiment of a self-centering air bag.

FIG. 12 illustrates a sample embodiment of a restraint system before the self-centering air bag has been deployed.

FIG. 13 illustrates a portion of a restraint system shown in FIG. 12 after the self-centering air bag has been deployed. This view is a 180 degree rotation about the vertical of the view shown in FIG. 12.

### DETAILED DESCRIPTION OF THE PREFERRED EMBODIMENTS

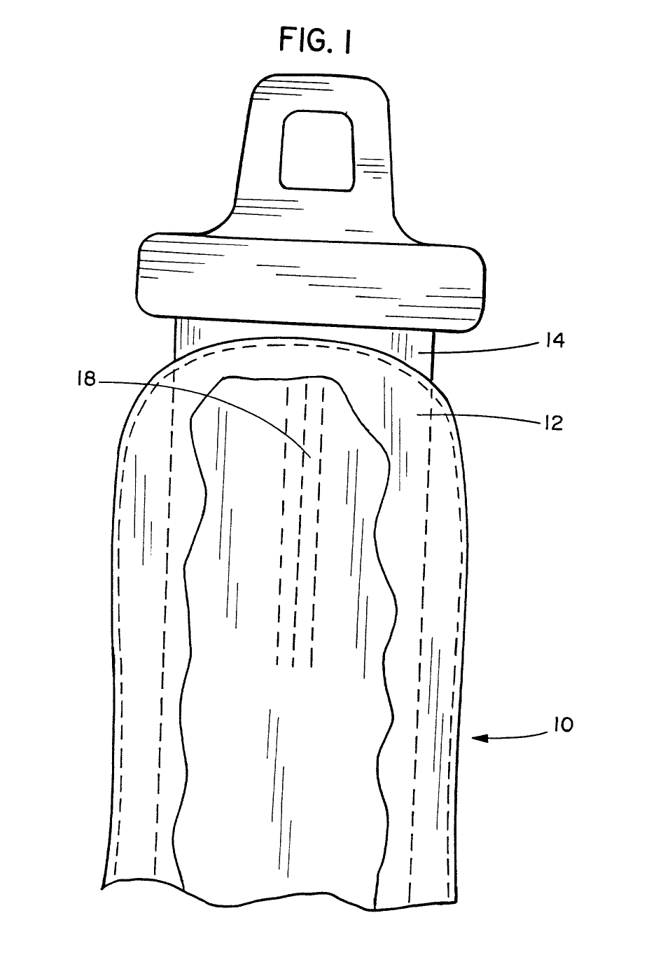

An exemplary air bag cover of the present invention is shown generally in FIG. 1 at 10. As shown in FIG. 1, an outer air bag cover 12 encloses both a belt type restraining device 14 as well as a folded air bag 16 prior to deployment of the air bag. Preferably, the outer perimeter of the air bag cover is stitched down to the belt restraining device 14. Alternatively, the cover may completely surround the restraining belt and bag assembly.

As shown in FIG. 1, the cover 12 includes a preferably located central portion 18 where the strength of the material for the outer cover bag has been reduced through, for example, ultrasonic stitching or through chemical treatment, mechanical wear or laser treatment. This weakened portion or region may alternatively be comprised of a connection between separate portions of the cover material that is not as strong as the connection between other portions of the cover material. Advantageously, the weakened portion of the air bag cover provides for the rapid deployment of the air bag through the cover. The selective placement of the weakened portion may also be used in controlling the selective deployment of the air bag.

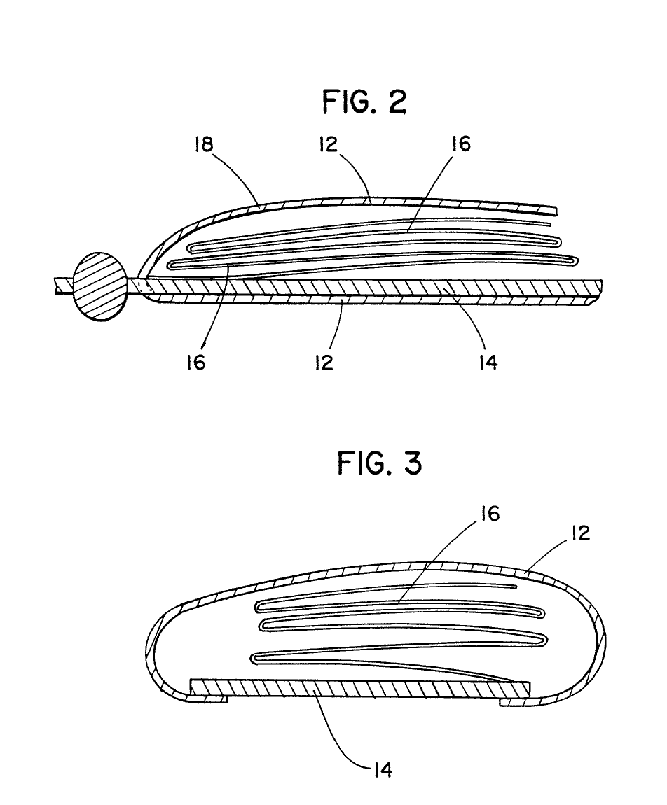

FIG. 2 is a side view illustration of the air bag cover mechanism of the present invention. As shown in FIG. 2, in this embodiment, the cover 12 completely surrounds the seatbelt 14 as well as an internally located folded air bag 16. The weakened portion or region of the air bag cover having decreased strength 18 is located on the top surface preferably in the center. As noted, the actual location of the cover region 18 having decreased strength may be selected in order to alter initial bag deployment. For example, it is preferred that this region be centrally located to allow for more uniform deployment of the bag in front of a passenger. However, other selections for the location of the cover region having decreased strength may be used as well.

As noted above, the fabric cover may be sewn to the restraining belt or the cover member may surround both the air bag 16 and the restraining belt 14. A single piece of cover material may be sewn directly to the restraining belt 14 where mechanical wear or etching or some other technique for decreasing the strength of the air bag cover has been employed for weakening a selected area.

FIG. 3 illustrates a further alternate embodiment of the invention where the cover material 12 is attached to the underside portions of the belt restraining device 14. The weak portion 18 of the air bag cover 12 is also preferably centrally located in this embodiment. The air bag material may be comprised of a polymer material whose weakened portion 18 has been formed by mechanical wear, laser treatment, chemical etching or ultrasonic stitching. The weakened area 18 will tear first and the bag will deploy and expand initially outward from the weakened region 18.

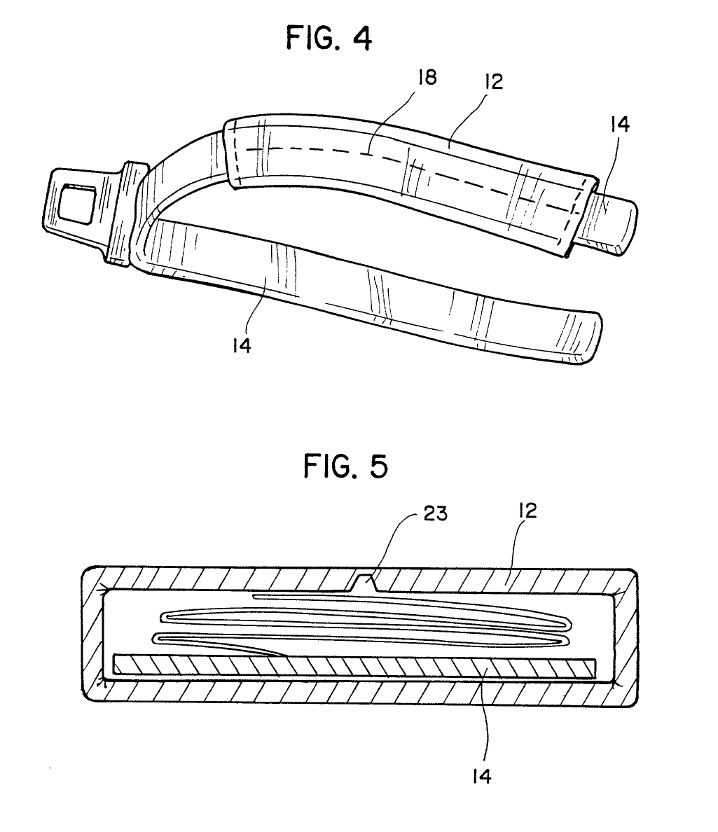

In the embodiment illustrated in FIG. 4, the cover 12 is a unitary member which slides over the bag/belt assembly. The ends of this cover material 12 may be stitched to the safety belt 14 in order to limit access to the air bag material thereby making the unit tamper resistant. The weakened portion 18 of this embodiment may also be formed as noted above. It is preferred that this unitary member be formed as a plastic extrusion made from a polymer material. In a further preferred embodiment, the weakened area may be comprised of an integrally molded tear seam wherein a portion of the polymer cover material is less thick than other regions of the cover thereby providing a weakened area that tears initially during deployment of an air bag. FIG. 5 is a side view that illustrates this embodiment of the air bag cover 12, wherein the cover has a preferably internally located region 23 that is thinner than the remain portions of the cover 12.

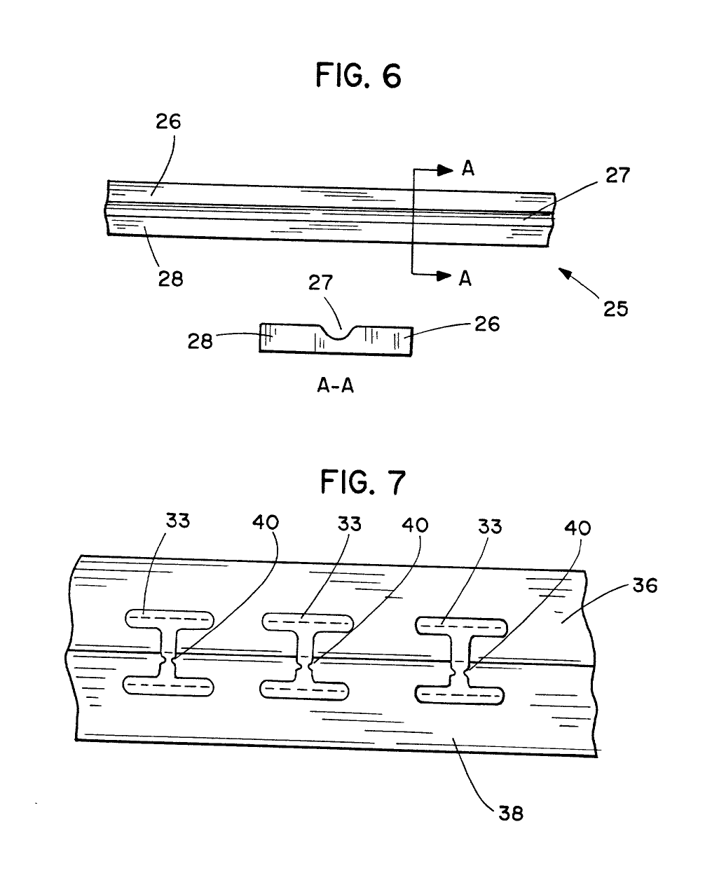

FIG. 6 illustrates a further alternate embodiment of the present invention which is comprised of a tear seam that may be attached between two portions of the cover material to provide ready separation of the cover regions. In this embodiment, the tear seam 25 is preferably comprised of a polymer material having a preferably located central portion 27 that is thinner than the remaining regions. The sides of the tear strip 26, 28 may be secured to cover material via any conventional manner such as, for example, via mechanical stitching, or ultrasonic welding and the like. The tear strip allows two air bag cover portions to readily separate during deployment of the air bag.

FIG. 7 illustrates yet another alternate embodiment of the present invention wherein I-shaped connection elements 33 are secured between two flaps 36, 38 of cover material. Desirably the I-shaped connection elements 33 have a central portion 40 that has a weakened region that will break during deployment of an air bag. The weakened region may be provided by a thickness that is physically smaller than that of the first end 42 and the second end 44. In addition to the manner in which it is shown in FIG. 7, the thickness may alternatively be defined in a plane perpendicular to the page or in both planes. Alternately or in addition to defining the thickness, the central portion 40 may be weakened by perforation or other such technique. The I-shaped members 33 are attached to the adjacent flap members 36, 38 of the cover material via either mechanical stitching or ultrasonic welding or the like. The I-shaped members 33 are preferably secured beneath the top surface of the overlapping flaps, however, those skilled in the art will recognize that they may be formed on the top surface as well. During deployment, as the pressure beneath the flaps 36, 38 increases, the connection elements 33 begin to break and the air bag expands out from the cover.

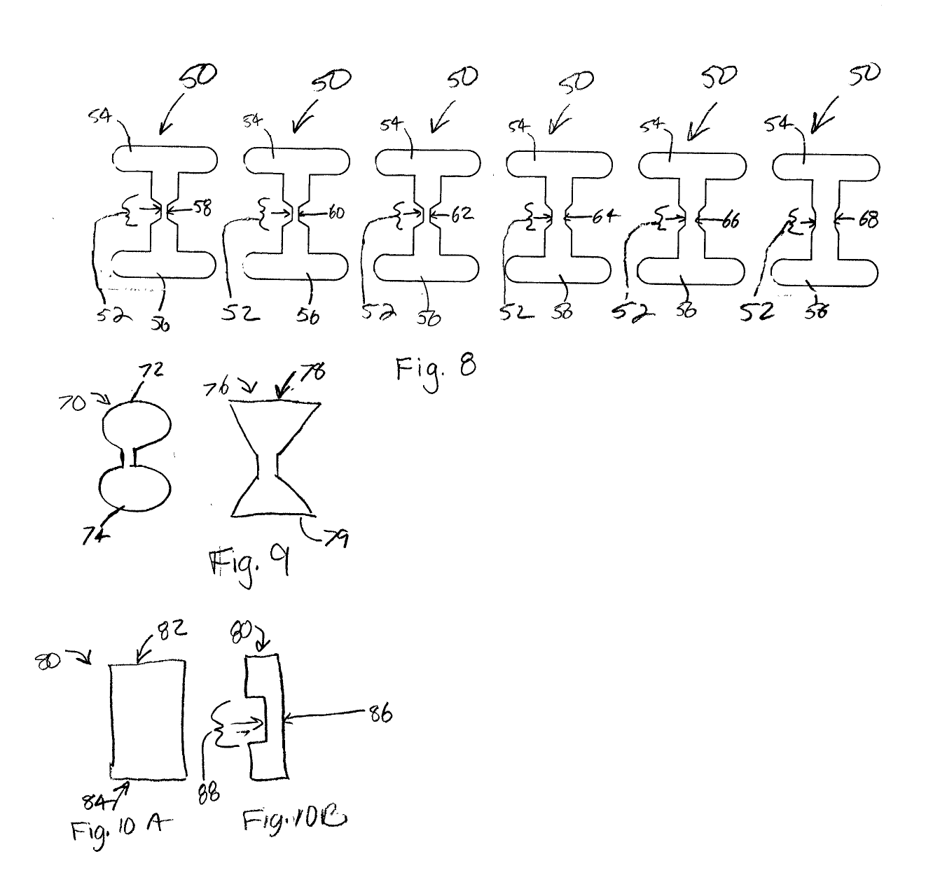

In an alternate embodiment, shown in FIG. 8, the connecting members 50 may include central portions 52 of varying thicknesses 58-68. These central portions 52 therefore have varying degrees of mechanical weakness that are proportional to their thickness 58-68. Upon deployment of the air bag, the connection elements will break in an order that is dictated by their thickness. The connection elements with smaller thicknesses 58 have less mechanical strength and therefore will break first, with the connection elements with progressively larger thicknesses breaking in turn 60-68. Therefore, this mechanism provides a method for controlling the deployment of an air bag. Connection elements with the smaller thicknesses are placed over the portion of the air bag that is to be deployed first and connection elements with larger thickness are placed over the other portions of the air bag that are to be deployed later.

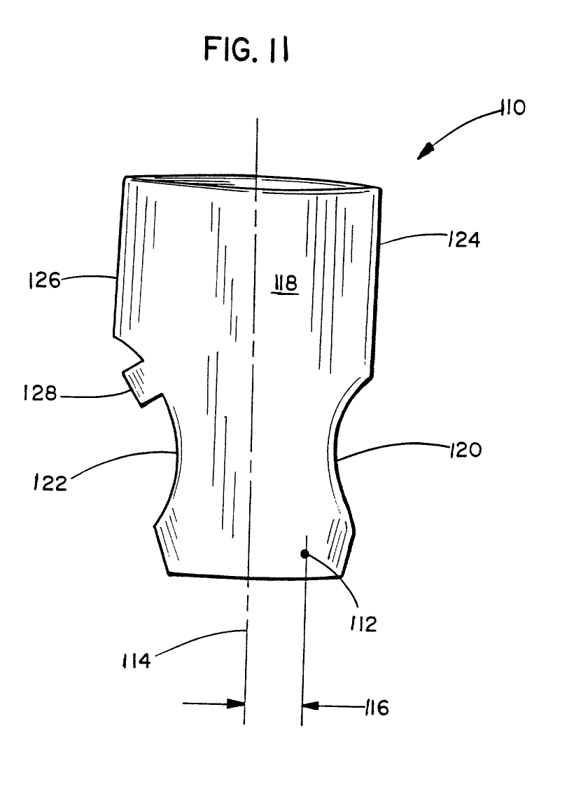

The first and second ends of the air bag may come in a variety of shapes and sizes. FIG. 9 shows connection elements 72 and 78 with various shapes. The first end and the second end may have curved edges 72 and 74 or straight edges 78 or 79 or a combination of straight and curved edges (not shown). In another embodiment, the thickness of the connection element may be defined in a plane perpendicular to that shown in FIGS. 8 and 9. FIGS. 10A and 10B show a connection element 80, including a first end 82, a second end 84 and a central portion 88. The thickness of the central portion 86 may be varied to vary the mechanical strength of the connection element 80 as described above. It should also be appreciated that the thickness may be varied in either plane or both and that the connection elements may come in a variety of shapes and sizes.

Another method for controlling the deployment of an air bag is the self-centering air bag. FIG. 11 shows a self-centering air bag 10 in its fully deployed state. The air bag 110 can have a single chamber. The self-centering air bag has a shape or footprint 118, a self-centering air bag centerline 114 and fixation point 112. The particular footprint 118 shown in FIG. 11 is illustrative only and it should be understood that the footprint can assume a wide variety of shapes. In this embodiment, the self-centering air bag 110 has a first vertical side 124 with a first cutout 120, a second vertical side 126 with a second cutout 122. The self-centering air bag also includes a pressure release valve 128 which is preferably located so that when the self-centering air bag 110 is deployed, the pressure release valve 128 does not contact the passenger. The fixation point 112 is the point where the self-centering air bag is attached to a structure such as seatbelt, seat or other structure. The fixation point is offset a distance, the offset distance 116, from the self-centering air bag centerline 114.

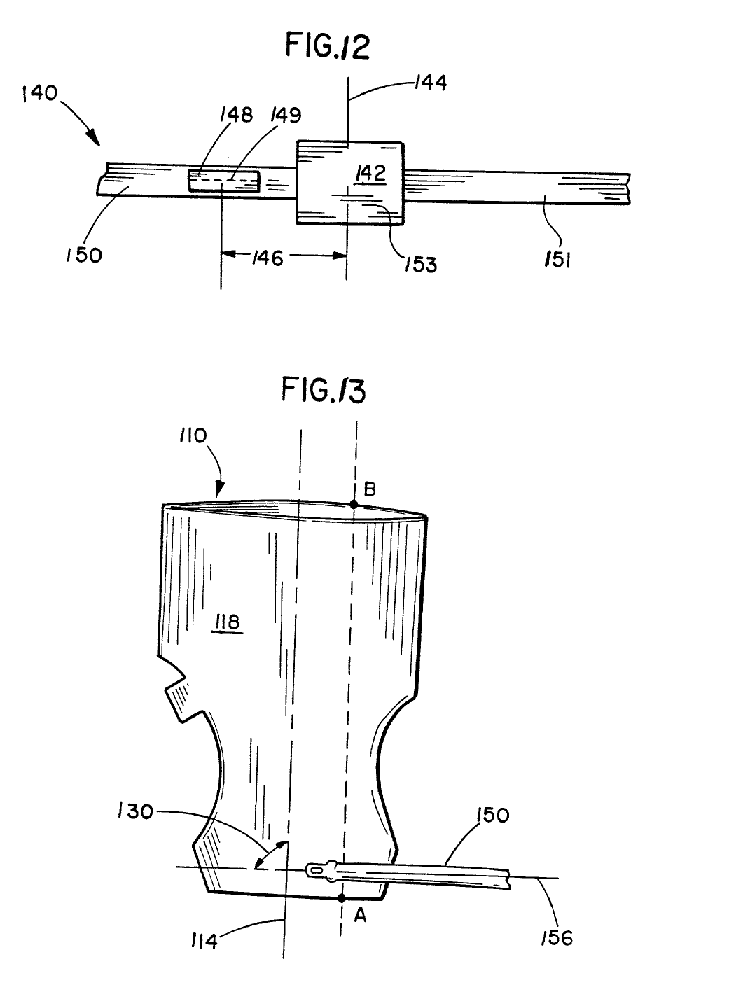

As shown in FIGS. 12 and 13, the self-centering air bag 110 can be used as part of a restraint system. In one embodiment, the restraint system 140 generally includes a safety belt 142 and a self-centering air bag 110 embedded within the safety belt 142. FIG. 12 shows the system when the self-centering air bag 110 has not been deployed, while FIG. 13 shows the system rotated 180 degrees about the vertical, after the self-centering air bag 110 has been deployed. The safety belt 142, shown in FIGS. 12 and 13 as a lap belt, is comprised of a fixed length belt 150, an adjustable length belt 151, and a buckle 153 that secures the fixed and adjustable length belts around the passenger's lap. The safety belt 142 also includes a centerline 144 and a horizontal centerline 156. In FIGS. 12 and 13, the self-centering air bag 110 is attached to the fixed length belt 150, however, its location is not so limited. In FIG. 12 the self-centering air bag 110 is embedded in the belt 142 a distance 146 from the centerline 144. The self-centering air bag is fixedly attached to the belt 142 at its fixation point 112, shown in FIG. 11. The self-centering airbag 110 is fixed to the belt 142 so as to create an angle 130 between the self-centering air bag centerline 114 and the horizontal centerline 156 of the belt 142. The footprint 118 of the self-centering air bag 110 is chosen so that when the self-centering air bag 110 is deployed, the self-centering air bag centerline 114 is located so as to provide the passenger with optimal protection in a crash event. As shown in FIG. 112 the self-centering air bag 110 is generally covered by a durable fabric cover 148 that includes a tearseam 149. Upon deployment of the self-centering air bag 110, the pressure of the expanding self-centering air bag causes the durable fabric cover 148 to separate along the tearseam 149, thus allowing the self-centering air bag to deploy into its fully inflated state, as shown in FIG. 13.

In order to ensure that when deployed, the self-centering air bag centerline 114 ends up in the desired location, (this will be referred to as “tuning” the air bag) sculpturing is used to manufacture the self-centering air bag. Sculpturing the self-centering air bag entails creating cutouts such as those shown in FIG. 11 and indicated by numerals 120 and 122. The shape, size, location and number of the cutouts are chosen based, among other factors, on the material used to fabricate the self-centering air bag and the desired location of the self-centering air bag centerline when the self-centering air bag is deployed. In general, when deployed, the self-centering air bag will tend to pull in the direction of a cutout. FIG. 11 shows one possible footprint 118 that is the result of sculpturing the self-centering air bag 110.

Along with sculpturing the self-centering air bag, the self-centering air bag may also be tuned by several other methods. These methods can be used alone or in any combination. One method comprises altering the offset distance 116 between the self-centering air bag centerline 114 and the fixation point 112. Another method includes varying the angle 310. The self-centering air bag 10 may also be tuned by varying the way in which the self-centering air bag 10 is folded in preparation for deployment. For example, in FIG. 13 the self-centering air bag is first folded along line A-B so that the first vertical edge 26 is folded into the page. The self-centering air bag 110 is then, starting at a short distance from its top, is folded horizontally. This procedure is repeated until the height of the self-centering air bag is smaller than the width of belt 142 so that the self-centering air bag can be embedded within the belt.

In another embodiment of the present invention, a self-centering air bag is used in combination with the connection elements of varying thickness to control the deployment of the air bag. By attaching any of the connecting elements 50, 70, 76 or 80 shown in FIGS. 8, 9, and 10 to an air bag cover, the manner in which the air bag is deployed and self-centers can be manipulated. For instance, a self-centering air bag, containing cut-outs as shown in FIG. 11, is folded so that at least part of the cut-out will engage the underside of the air bag cover when the self-centering air bag is enclosed in the restraint system. Connecting elements with varying thicknesses are affixed to the air bag cover. The connecting elements with the smaller thicknesses are placed above the cut-outs of the self-centering air bag and the connecting elements with progressively thicker center portions are placed progressively further away from the smaller-thickness connecting elements. This configuration helps the cut-outs of the air bag to break the connecting elements and deploy first and begin to center more quickly. Alternatively, the smaller-thickness connecting elements may be placed above the air bag and away from the cut-out portions to provide a more even deployment of the air bag. It should be appreciated that the foregoing is for the purposes of example and that numerous combinations of self-centering air bag footprints, fixation point, angle, folding and configuration of connecting elements with varying thicknesses is possible to achieve various controlled deployments.

The present invention has been described with respect to the exemplary embodiments and is subject to many variations and modifications that nevertheless fall within the spirit and scope of the appended claims.

We claim:

1. A connection member for use with an air bag cover, comprising:
a first end;
a second end; and
a central portion, wherein the central portion has less mechanical strength than the first end and the second end.

2. A connection member as claimed in claim 1, wherein the first end, the second end and the central portion all include a thickness and the thickness of the central portion is smaller than that of the first end and the second end.

3. A connection member as claimed in claim 2 wherein the connection member is I-shaped.

4. An air bag cover comprising:
first and second portions of cover material, at least one of said first and second portions of cover material located over an air bag;
at least one connection member including at least one central portion, wherein the at least one connection member is connected to the first and second portions of cover material, said cental portion having a mechanical strength that is less than a mechanical strength of the cover material.

5. An air bag cover as claimed in claim 4, further comprising a plurality of connection members wherein the central portion of each has a thickness.

6. An air bag cover as claimed in claim 5, wherein the thickness of each central portion may vary.

7. An air bag cover as claimed in claim 6, wherein the connection element is I-shaped.

8. A restraint system, comprising:
a seatbelt;
an air bag located within the seatbelt; and
an air bag cover affixed to the seatbelt and covering the air bag, comprising
first and second portions of cover material, at least one of said first and second portions of cover material located over an air bag;
at least one connection element each including at least one central portion, wherein the at least one connection element is connected to the first and second portions of cover material, said cental portion having a mechanical strength that is less than a mechanical strength of the cover material.

9. A restraint system as claimed in claim 8, further comprising a plurality of connection elements wherein the central portion of each has a thickness.

10. A restraint system as claimed in claim 9 wherein the thicknesses of each central portion may vary.

11. An restraint system as claimed in claim 10 wherein the air bag is a self-centering air bag.

12. An restraint system as claimed in claim 11 wherein the self-centering air bag is sculptured.

13. A method for controlling the deployment of an air bag embedded within a seat belt and covered by an air bag cover wherein the air bag cover includes connection elements each with a central portion, comprising varying the thickness of the connection elements.

14. A method for controlling the deployment of an air bag as claimed in claim 13, further comprising sculpturing the air bag.

15. A method for controlling the deployment of an air bag as claimed in claim 14, wherein the air bag includes a footprint and sculpturing the air bag comprises including at least one cutout in the footprint.

16. A method for controlling the deployment of an air bag as claimed in claim 15, wherein the thickness of the connection elements is varied so that the connection elements with the smallest thicknesses will be broken by the cutout when the air bag is deployed.

17. A method for controlling the deployment of an air bag as claimed in claim 15, wherein the thickness of the connection elements is varied so that the connection elements with the largest thicknesses will be broken by the cutout when the air bag is deployed.
